(19) United States
(12) Patent Application Publication
(10) Pub. No.: US 2016/0243714 A1
(43) Pub. Date: Aug. 25, 2016

(54) Handheld Vegetable Julienne Cutter

(71) Applicant: Halina Kopec, Tomball, TX (US)

(72) Inventor: Halina Kopec, Tomball, TX (US)

(21) Appl. No.: 14/628,481

(22) Filed: Feb. 23, 2015

(51) Int. Cl. B26D 3/18

(52) U.S. Cl. CPC B26D 3/185

(57) ABSTRACT

A handheld vegetable julienne cutter comprises an upper handle and a lower handle pivotally connected by a handle pivot; a vegetable holder in the lower handle with griddle knives in the bottom end of the vegetable holder; a vegetable press in the upper handle, wherein the vegetable press is positioned to pass through the vegetable holder when the upper handle and lower handle are pressed together; and vegetable cutting blades comprising a series of interchangeable blades with various spacing dimensions.

### CROSS-REFERENCES TO RELATED APPLICATIONS

Not Applicable

### FEDERALLY SPONSORED RESEARCH OR DEVELOPMENT

Not Applicable

### SEQUENCE LISTING, TABLE, OR COMPUTER LISTING

Not Applicable

### BACKGROUND OF THE INVENTION

1. Field of the Invention

The present invention relates generally to the field of vegetable slicers. More particularly, the invention relates to the field of handheld vegetable julienne cutters.

2. Description of the Related Art

Food cutters and graters suitable for vegetables such as carrots have been considered in the past. Different types of vegetable cutters include handheld push through vegetable cutters with griddle knives, handheld crank-powered food cutters, handheld lever-powered food cutters, mandolin style vegetable cutters, and vegetable cutters with a container with a crank-powered vegetable pusher. The following patents are representative of such devices.

An example of a handheld push through vegetable cutter with griddle knives is disclosed in U.S. Pat. No. 5,063,674, issued Nov. 12, 1991 to Geoffrey D. Rowell. In the Rowell patent, a handheld vegetable cutter comprises a handle connected to a holder of transverse blades. Vegetables are julienne sliced by manually pushing vegetable pieces through the blades in the holder.

Examples of handheld crank-powered food cutters are disclosed in U.S. Pat. No. 6,915,973 B2, issued Jul. 12, 2005 to Kwok Kuen So and U.S. Pat. No. 7,337,997 B2, issued Mar. 4, 2008 to Kon Yi Ko. In the former So patent, vegetable pieces are manually pushed down by the handle onto a barrel surface where a manually-powered hand crank rotates cutting blades through the barrel surface to cut the vegetable pieces. The food cutter is said to be used to grate solid food items such as cheese and carrots and to julienne slice only lighter food such as parsley. In the latter Ko patent, vegetable pieces are manually pushed down by the handle onto a drum surface with cutting blades where a manually-powered hand crank rotates the drum to cut the vegetable pieces.

Examples of handheld lever-powered food cutters are disclosed in U.S. Pat. No. 6,409,107 B1, issued Jun. 25, 2002 to John J. Romano and U.S. Pat. No. 7,637,445 B2, issued Dec. 25, 2009 to Kwok Kwen So et al. In the former Romano patent, the manually-powered handle pushes vegetable pieces down onto a manually-powered handle lever moving a slicing or grating platform back and forth. In the latter So patent, a manually-powered thumb device pushes vegetable pieces down onto a manually-powered handle lever rotating a slicing or grating cylinder.

An example of a mandolin style vegetable cutter is disclosed in U.S. Pat. No. 7,690,285 B2, issued Apr. 6, 2010 to Julien de Buyer. Mandolin vegetable cutters are usually free-standing on legs and employ a selection of typically v-shaped removable blades for different kinds of cuts, including julienne. Typically, as in the de Buyer patent, all the extra blades are stored under the device. Switching blades is cumbersome and potentially dangerous.

An example of a vegetable cutter with a container with a crank-powered vegetable pusher is disclosed in U.S. Pat. No. 8,596,192 B2, issued Dec. 3, 2013 to Lawrence M. Hauser et al.. In the Hauser et al. patent, various plates with slicing blades are positioned in a container that is free standing. A manually-powered crank pushes vegetable pieces down onto the blades and rotates the vegetable pieces so that they are sliced by the blades.

Thus, a need exists for handheld vegetable julienne cutter that is safe, simple, easily portable, and cuts appropriately-sized julienne slices.

### BRIEF SUMMARY OF THE INVENTION

In one embodiment, the invention is a handheld vegetable julienne cutter comprising an upper handle and a lower handle pivotally connected by a handle pivot; a vegetable holder in the lower handle with griddle knives in the bottom end of the vegetable holder; a vegetable press in the upper handle, wherein the vegetable press is positioned to pass through the vegetable holder when the upper handle and lower handle are pressed together; and vegetable cutting blades comprising a series of interchangeable blades with various spacing dimensions.

In an alternative embodiment, the invention is a method for employing a handheld vegetable julienne cutter, comprising moving an upper handle and a lower handle of a handheld vegetable julienne cutter apart to raise a vegetable press connected to the upper handle to allow access to a vegetable holder interior of a vegetable holder connected to the lower handle; inserting a vegetable piece into the vegetable holder interior; pushing the upper handle and the lower handle manually together to push the vegetable press to force the vegetable piece through the vegetable holder; pushing the vegetable piece through griddle knives at a bottom end of the vegetable holder; and emerging the vegetable piece from the griddle knives as julienne slices.

### BRIEF DESCRIPTION OF THE DRAWINGS

The invention and its advantages may be more easily understood by reference to the following detailed description and the attached drawings, in which:

FIG. 1 shows a schematic side view of an embodiment of a handheld vegetable julienne cutter;

FIG. 2 shows a schematic side view of the vegetable press and vegetable holder of the vegetable cutter corresponding to FIG. 1;

FIG. 3 shows a schematic bottom view of the vegetable press of the vegetable cutter corresponding to FIGS. 1-2;

FIG. 4 shows a schematic bottom view of the vegetable holder of the vegetable cutter corresponding to FIGS. 1-2;

FIG. 5 shows a schematic bottom view of an alternative embodiment of the vegetable holder of the vegetable cutter corresponding to FIGS. 1-2;

FIG. 6 shows a schematic side view of an alternative embodiment of a handheld vegetable julienne cutter;

FIG. 7 shows a schematic side view of the vegetable press and vegetable holder of the vegetable cutter corresponding to FIG. 6;

FIG. 8 shows a schematic side view of another alternative embodiment of a handheld vegetable julienne cutter.

FIG. 9 shows a schematic side view of the vegetable press and vegetable holder of the vegetable cutter corresponding to FIG. 8; and

FIG. 10 shows a flowchart illustrating an embodiment of a method corresponding to the invention for employing the handheld vegetable julienne cutter shown in FIGS. 1, 6 and 8.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

The invention, in various embodiments, is a handheld vegetable julienne cutter. In particular, the invention is suitable as a handheld carrot julienne cutter.

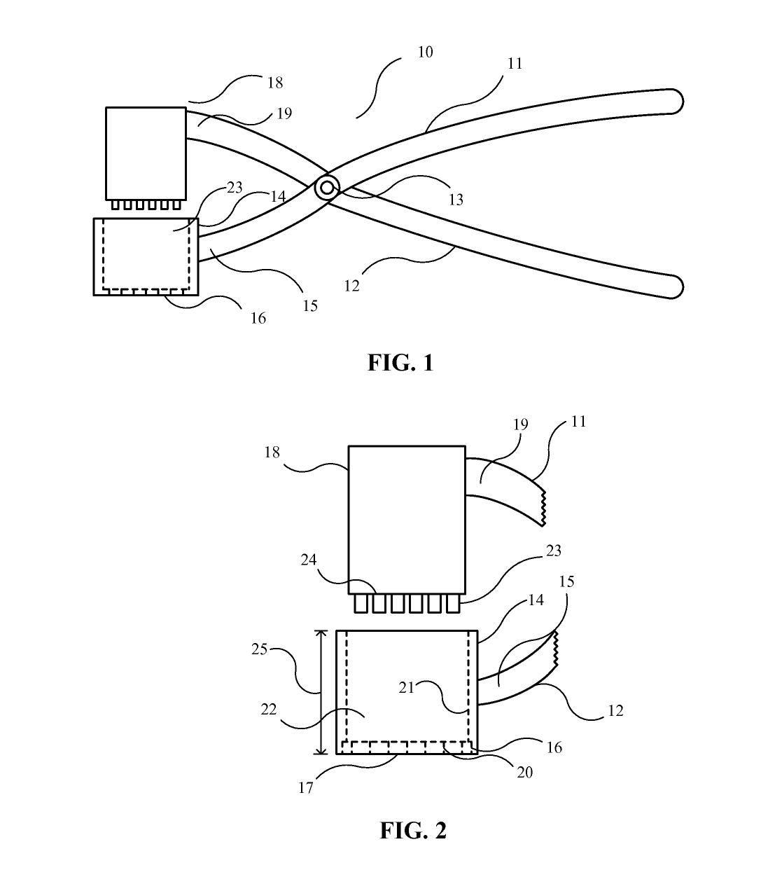

FIG. 1 shows a schematic side view (not necessarily to scale) of an embodiment of a handheld vegetable julienne cutter, such as may be used according to the present invention. The vegetable cutter is designated in general by the reference numeral 10.

This exemplary vegetable cutter 10 comprises an upper handle 11 and a lower handle 12. The upper handle 11 and the lower handle 12 are pivotally connected by a handle pivot 13. The lower handle 12 further comprises a vegetable holder 14 connected at the front end 15 of the lower handle 12. The vegetable holder 14 further comprises griddle knives 16 in the bottom end 17 of the vegetable holder 14. The upper handle 11 further comprises a vegetable press 18 connected to the front end 19 of the upper handle 11. The handle pivot 13 is positioned in the middles of the upper handle 11 and the lower handle 12. The pliers-style configuration provides for mechanical advantage (leverage) in cutting vegetables.

FIG. 2 shows a schematic side view (not necessarily to scale) of the vegetable holder 14 and the vegetable press 18 of the vegetable cutter 10 corresponding to FIG. 1. The griddle knives 16 in the vegetable holder 14 further comprise a plurality of vegetable cutting blades 20. The vegetable holder 14 further comprises vegetable holder internal walls 21 that define a vegetable holder interior 22. The vegetable cutting blades 20 are employed to cut vegetable pieces that are placed in the vegetable holder interior 22 in the vegetable holder 14.

The vegetable press 18 further comprises vegetable press teeth 23 on the bottom end 24 of the vegetable press 18 that aid in pushing the vegetable pieces through the vegetable holder interior 22 in the vegetable holder 14 and then completely through the vegetable cutting blades 20 in the griddle knives 16. This pushing results in the vegetable pieces being cut into julienne slices. In a preferred embodiment, the vegetable holder height 25 of the vegetable holder 14 is approximately 5.08 cm (2 inches).

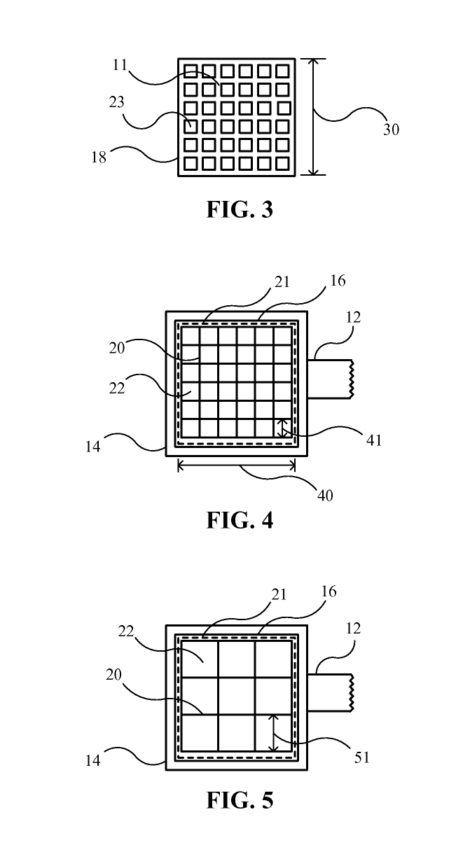

FIG. 3 shows a schematic bottom view (not necessarily to scale) of the vegetable press 18 of the vegetable cutter 10 corresponding to FIGS. 1-2. This bottom view illustrates the positioning of the vegetable press teeth 23 protruding from the bottom end 24 of the vegetable press 18. This positioning allows the vegetable press teeth 23 to line up with and pass through the openings between the vegetable cutting blades 20 in the griddle knives 16. This spacing thus further aids in cutting the vegetable pieces into julienne slices. In a preferred embodiment, the vegetable press width 30 of the vegetable press 18 is approximately 3.81 cm (1.5 inches).

FIG. 4 shows a schematic bottom view (not necessarily to scale) of the vegetable holder 14 of the vegetable cutter 10 corresponding to FIGS. 1-2. This bottom view illustrates the positioning of the vegetable cutting blades 20 in the griddle knives 16. As noted above, this positioning allows the vegetable press teeth 23 to line up with the openings between the vegetable cutting blades 20 and thus further aids in cutting the vegetable pieces into julienne slices. The interior width 40 of the vegetable holder interior 22 is slightly larger than the vegetable press width 30 of the vegetable press 18 (shown in FIG. 3) to allow the vegetable press 18 to fit into the vegetable holder interior 22. Thus, in the preferred embodiment, the interior width 40 of the vegetable holder interior 22 is approximately 3.81 cm (1.5 inches). In a preferred embodiment, the spacing 41 between the vegetable cutting blades 20 is approximately 0.125 cm (0.25 inches).

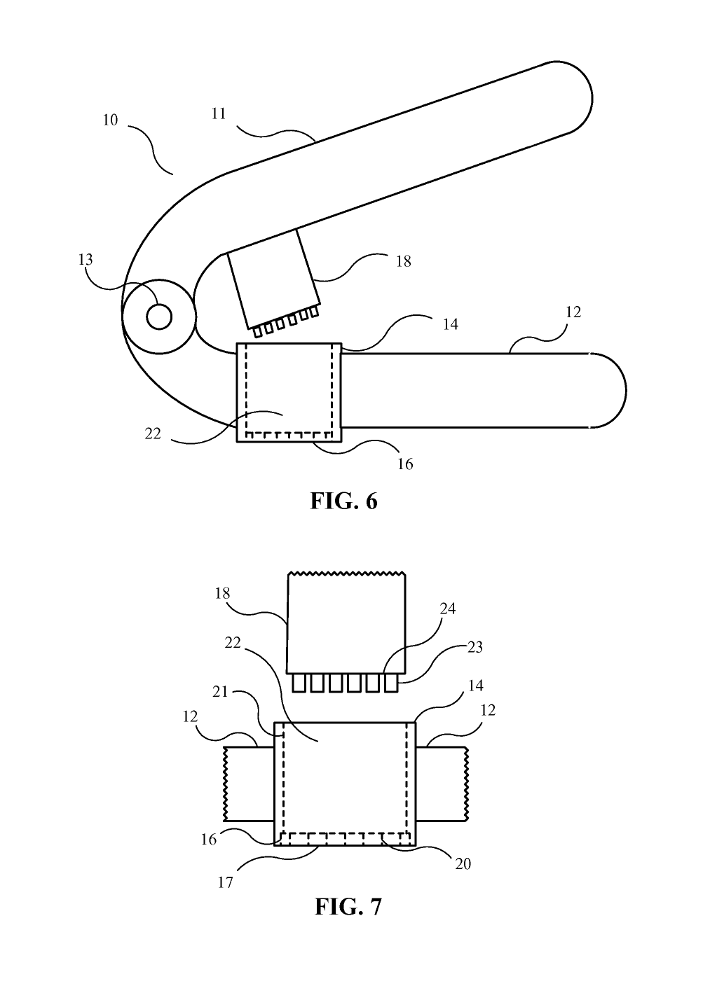

FIG. 5 shows a schematic bottom view (not necessarily to scale) of an alternative embodiment of the vegetable holder 14 of the vegetable cutter 10 corresponding to FIGS. 1-2. This bottom view illustrates an alternative positioning of the vegetable cutting blades 20 in the griddle knives 16. In this embodiment, the spacing 51 between the vegetable cutting blades 20 is twice the spacing as the spacing 41 illustrated in FIG. 4. Thus, for the preferred spacing of approximately 0.64 cm (0.25 inch) illustrated in FIG. 4, the spacing 51 between the vegetable cutting blades 20 is approximately 1.27 cm (0.5 inches). The spacing 51 between the vegetable cutting blades 20 in FIG. 5 is a multiple of the spacing 41 between the vegetable cutting blades 20 in FIG. 6. This spacing 51 allows the vegetable press teeth 23 to still line up with the openings between the vegetable cutting blades 20 and thus still aids in cutting the vegetable pieces into julienne slices.

In an alternative embodiment, the griddle knives 16 are detachable from the bottom end 17 of the vegetable holder 14. This aids the interchangeability of the vegetable cutting blades 20 with different spacing 41, 51, as shown in FIGS. 4 and 5, respectively. in another alternative embodiment, the vegetable holder 14 and the vegetable press 18 are detachable from the lower handle 12 and the upper handle 11, respectively.

FIG. 6 shows a schematic side view (not necessarily to scale) of an alternative embodiment of a handheld vegetable julienne cutter. In this exemplary alternative embodiment, the handle pivot 13 is repositioned. Instead of being positioned behind the vegetable holder 14 and the vegetable press 18 of the vegetable cutter 10, as shown in the embodiment illustrated in FIG. 1, the handle pivot 13 is here positioned in front of the vegetable holder 14 and the vegetable press 16 in FIG. 6, at the front of the upper handle 11 and the lower handle 12. Accordingly, the vegetable holder 14 is integrated directly into the lower handle 12 and the vegetable press 18 is integrated directly into the upper handle 11.

FIG. 7 shows a schematic side view (not necessarily to scale) of the vegetable holder 14 and the vegetable press 18 of the alternative embodiment of the vegetable cutter 10 corresponding to FIG. 6. FIG. 7 is similar to FIG. 2 except for the manner in which the vegetable holder 14 is connected to the lower handle 12 and the vegetable press 18 is connected to the upper handle 11.

further comprises vegetable press teeth 23 on the bottom end 24 of the vegetable press 18 that aid in pushing the vegetable pieces through the vegetable holder interior 22 in the vegetable holder 14 and then completely through the vegetable cutting blades 20 in the griddle knives 16. This pushing results in the vegetable pieces being cut into julienne slices.

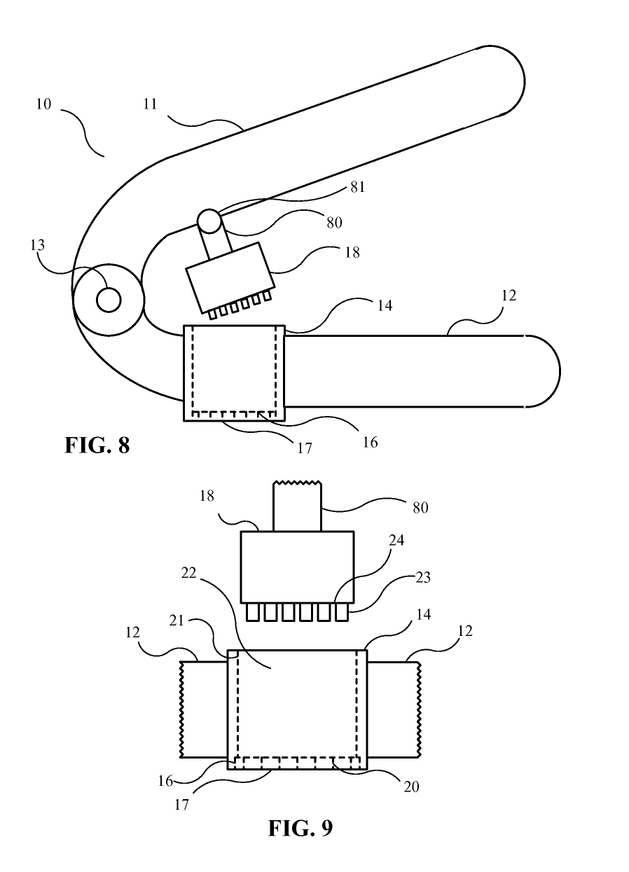

FIG. 8 shows a schematic side view (not necessarily to scale) of another alternative embodiment of a handheld vegetable julienne cutter. In this exemplary alternative embodiment, the handle pivot 13 is also positioned in front of the vegetable holder 14 and the vegetable press 17 of the vegetable cutter 10, as in FIG. 6. The vegetable press 18 is no longer integrated into the upper handle 11. Instead, the vegetable press 18 is connected to the upper handle 11 by a vegetable press support arm 80. The vegetable press support arm 80 is connected to the upper handle 11 by a support arm pivot 81. The support arm pivot 81 aids in directing the vegetable press 18 into the vegetable holder interior 22 of the vegetable holder 14.

FIG. 9 shows a schematic side view (not necessarily to scale) of the vegetable holder 14 and the vegetable press 18 of the alternative embodiment of the vegetable cutter 10 corresponding to FIG. 8. Again, FIG. 9 is similar to FIGS. 2 and 7 except for the manner in which the vegetable holder 14 is connected to the lower handle 12 and the vegetable press 18 is connected to the upper handle 11.

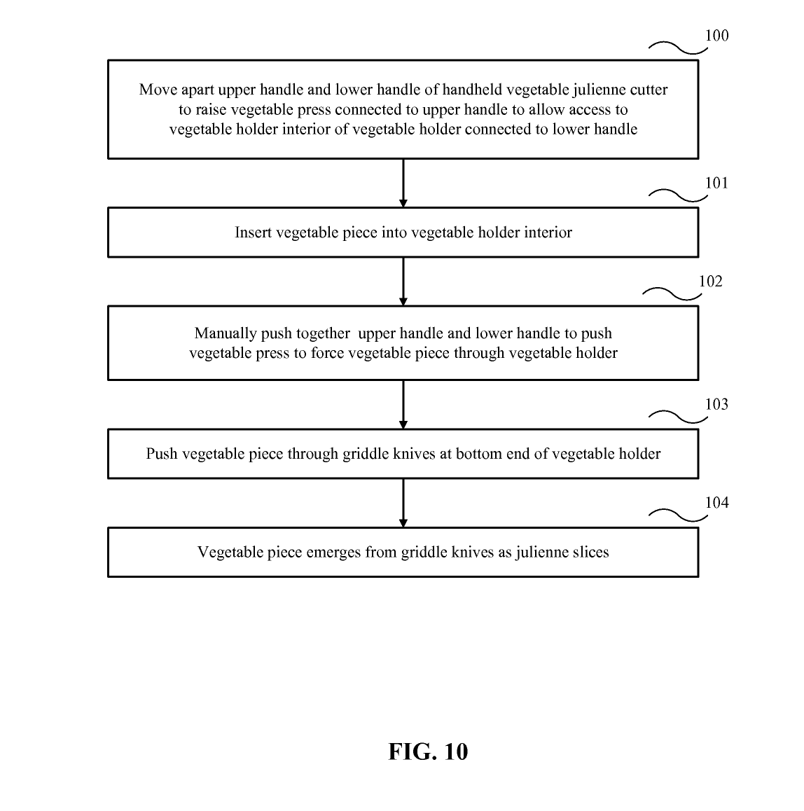

FIG. 10 shows a flowchart illustrating an embodiment of a method corresponding to the invention for employing the handheld vegetable julienne cutter shown in FIGS. 1, 6 and 8.

At block 100, an upper handle and a lower handle of a handheld vegetable julienne cutter are moved apart to raise a vegetable press connected to the upper handle to allow access to a vegetable holder interior of a vegetable holder connected to the lower handle.

At block 101, a vegetable piece is inserted into the vegetable holder interior from block 100. The vegetable piece preferably has dimensions of approximately 5.1 cm by 0.3 cm (2 inches by 1/8 inch) to fit in the vegetable holder interior.

At block 102, the upper handle and lower handle from block 100 are manually pushed together, pushing the vegetable press to force the vegetable piece from block 101 through the vegetable holder.

At block 103, the vegetable piece from block 102 is pushed through griddle knives at a bottom end of the vegetable holder from block 102.

At block 104, the vegetable piece from block 103 emerges from the griddle knives from block 103 as julienne slices.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

I claim:

1. A handheld vegetable julienne cutter, comprising:
an upper handle and a lower handle pivotally connected by a handle pivot;
a vegetable holder in the lower handle with griddle knives in the bottom end of the vegetable holder;
a vegetable press in the upper handle, wherein the vegetable press is positioned to pass through the vegetable holder when the upper handle and lower handle are pressed together; and
vegetable cutting blades comprising a series of interchangeable blades with various spacing dimensions.

2. The cutter of claim 1, wherein the vegetable holder further comprises:
vegetable holder internal walls defining a vegetable holder interior within the vegetable holder, wherein the vegetable cutting blades are positioned transversely in the griddle knives.

3. The cutter of claim 2, wherein the vegetable press further comprises:
vegetable push arms positioned on the bottom of the vegetable press, wherein the positioning of the vegetable push arms allows the vegetable push arms to line up with and pass through openings between the vegetable cutting blades in the griddle knives.

4. The cutter of claim 3, wherein the handle pivot is positioned in the middle of the upper handle and the lower handle, behind the vegetable press and the vegetable holder.

5. The cutter of claim 3, wherein the handle pivot is positioned at the front ends of the upper handle and the lower handle, in front of the vegetable press and the vegetable holder.

6. The cutter of claim 3, further comprising a vegetable press support arm connecting the upper handle and the vegetable press.

7. The cutter of claim 6, wherein the vegetable press support arm is connected to the upper handle by a support arm pivot.

8. The cutter of claim 3, wherein the vegetable press has a width of approximately 2.5 inches.

9. The cutter of claim 3, wherein the vegetable holder has a height of approximately 2 inches.

10. The cutter of claim 3, wherein the vegetable cutting blades have a spacing of approximately 0.25 inches.

11. The cutter of claim 3, wherein the vegetable cutting blades have a spacing of approximately 0.5 inches.

12. The cutter of claim 4, wherein the vegetable holder and vegetable press are detachable.

13. The cutter of claim 4, wherein the griddle knives are detachable.

14. A method for employing a handheld vegetable julienne cutter, comprising
moving an upper handle and a lower handle of a handheld vegetable julienne cutter apart to raise a vegetable press connected to the upper handle to allow access to a vegetable holder interior of a vegetable holder connected to the lower handle;
inserting a vegetable piece into the vegetable holder interior;
pushing the upper handle and the lower handle manually together to push the vegetable press to force the vegetable piece through the vegetable holder;
pushing the vegetable piece through griddle knives at a bottom end of the vegetable holder; and
emerging the vegetable piece from the griddle knives as julienne slices.
